(19) United States
(12) Patent Application Publication
(10) Pub. No.: US 2026/0205682 A1
(43) Pub. Date: Jul. 16, 2026

(54) DISPLAY APPARATUS, DISPLAY PROCESSING METHOD, AND STORAGE MEDIUM

(71) Applicant: CANON KABUSHIKI KAISHA, Tokyo (JP)

(72) Inventor: TAKASHI SASAKI, Kanagawa (JP)

(21) Appl. No.: 19/566,243

(22) Filed: Mar. 13, 2026

Related U.S. Application Data
(63) Continuation of application No. PCT/JP2024/029164, filed on Aug. 16, 2024.

(30) Foreign Application Priority Data
Oct. 30, 2023 (JP) 2023-185214

(51) Int. Cl. H04N 23/63; H04N 13/117; H04N 13/239; H04N 13/279; H04N 13/296; H04N 13/366; H04N 13/398; H04N 23/61

(52) U.S. Cl. CPC H04N 23/635; H04N 13/117; H04N 13/239; H04N 13/279; H04N 13/296; H04N 13/366; H04N 13/398; H04N 23/61

(57) ABSTRACT

A display apparatus is communicably connected to an image pickup apparatus. The display apparatus includes one or more memories storing instructions, one or more processors that, upon execution of the instructions, operate to detect an object that is present in a line-of-sight direction of a user, and generate spatial region information according to an angle of view of the image pickup apparatus and a region of the object, and a display unit configured to display the spatial region information.

### CROSS-REFERENCE TO RELATED APPLICATIONS

This application is a Continuation of International Patent Application No. PCT/JP2024/029164, filed on Aug. 16, 2024, which claims the benefit of Japanese Patent Application No. 2023-185214, filed on Oct. 30, 2023, both of which are hereby incorporated by reference herein in their entirety.

### BACKGROUND

### Field of the Technology

The present disclosure relates to a display apparatus, a display processing method, and a storage medium.

### Description of the Related Art

Conventionally, a three-dimensional modeling technology using images of a target object captured from a variety of angles has been known. More specifically, a technology called photogrammetry is proposed, which creates a three-dimensional model by analyzing and integrating a set of images captured while changing the position and orientation of a camera so as to surround the target object.

In order to check the angle of view of a camera, a user may look through a viewfinder, but in such a state, it is difficult for him to check his step or circumstances. In imaging (or shooting or capturing an image) for photogrammetry, since the user captures images while walking around the target object, attempting to check the angle of view while checking the circumstances makes the imaging operation arduous.

Japanese Patent Application Laid-Open No. 2016-201686 discloses a configuration that displays a region to be captured by a camera on a head-mounted display (HMD), thereby making it possible to visually recognize the imaging region even when an angular difference between the optical axis of the camera and a line of sight of the user is large.

### SUMMARY

A display apparatus according to one aspect of the present disclosure may be communicably connected to an image pickup apparatus. The display apparatus may include one or more memories storing instructions, one or more processors that, upon execution of the instructions, operate to detect an object that is present in a line-of-sight direction of a user, and generate spatial region information according to an angle of view of the image pickup apparatus and a region of the object, and a display unit configured to display the spatial region information. A display processing method corresponding to the display apparatus also constitutes another aspect of the present disclosure. A storage medium storing a program that causes a computer to execute the above display processing method also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a display processing system according to an embodiment of the present disclosure.

FIG. 2 is a diagram for explaining a coordinate system.

FIGS. 3A and 3B are flowcharts for explaining an operation of the display processing system.

FIG. 4 is a diagram for explaining image data acquired by a display apparatus.

FIG. 5 is a diagram for explaining assist information displayed on the display apparatus.

FIG. 6 is a diagram for explaining image data acquired by an image pickup apparatus.

FIG. 7 is a diagram for explaining a spatial region determined based on an angle of view of the image pickup apparatus and a region of an object.

FIG. 8 is a diagram for explaining imaging for photogrammetry.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure. Corresponding elements in respective figures will be designated by the same reference numerals, and a duplicate description thereof will be omitted.

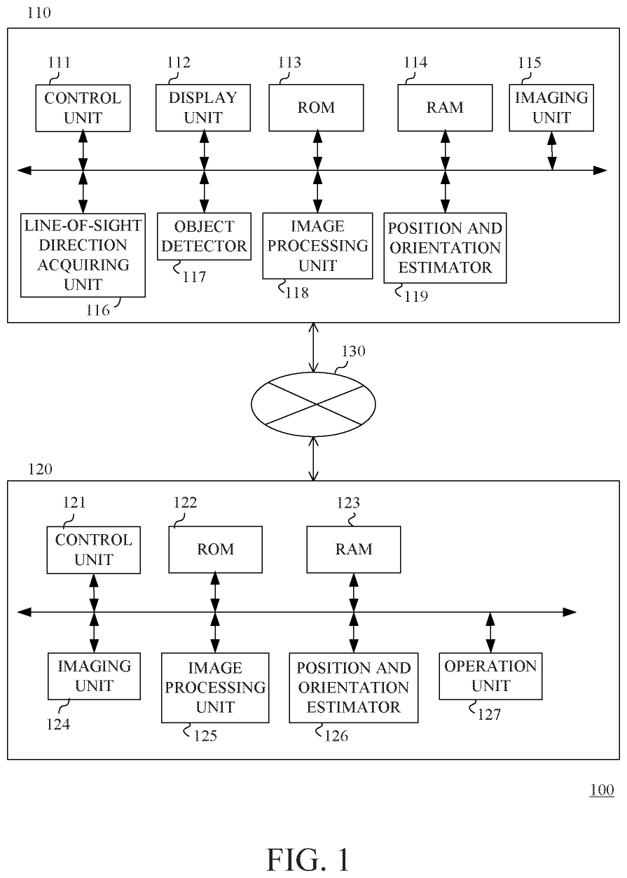

FIG. 1 is a block diagram of a display processing system 100 according to an embodiment of the present disclosure. The display processing system 100 includes a display apparatus 110, an image pickup apparatus 120, and a network 130. The display apparatus 110 and the image pickup apparatus 120 are connected so as to be capable of data communication via the network 130.

The display apparatus 110 is a device wearable on a head, such as a head-mounted display (HMD) or glasses-type display. In the present embodiment, the display apparatus 110 has a stereo camera configuration and is capable of acquiring a left-eye image and a right-eye image. The display apparatus 110 includes a control unit 111, a display unit 112, a ROM 113, a RAM 114, an imaging unit 115, a line-of-sight direction acquiring unit (acquiring unit) 116, an object detector (detector) 117, an image processing unit (generator) 118, and a position and orientation estimator 119. Thus, the display apparatus 110 includes one or more memories storing instructions, such as the ROM 113 and RAM 114, and one or more processors that, upon execution of the instructions, operate to serve as the control unit 111, the line-of-sight direction acquiring unit 116, the object detector 117, the image processing unit 118, and the position and orientation estimator 119.

The control unit 111 is, for example, a CPU, and controls operations of the respective blocks included in the display apparatus 110 by reading operation programs for the respective blocks from the ROM 113, developing the programs in the RAM 114, and executing the programs.

The display unit 112 is a non-transmissive display and is divided into a right-eye display and a left-eye display. An eyepiece lens is disposed between the user's eyes and the display unit 112. By displaying images captured by the imaging unit 115 on the display unit 112, the user can observe a space in front of the user. By displaying images or information such as Computer Graphics (CG) for imaging assistance on images displayed on the display unit 112, display images can be superimposed on the space viewed by the user through the display unit 112. A transmissive display may be used as the display unit 112.

The ROM 113 is a rewritable nonvolatile memory, and stores, in addition to operation programs for the respective blocks included in the display apparatus 110, parameters for operations of the respective blocks, captured image data, and the like.

The RAM 114 is a rewritable volatile memory, and is used as a temporary storage area for data output during operations of the respective blocks included in the display apparatus 110.

The imaging unit 115 includes an image sensor such as a CCD or CMOS sensor, an optical system, and an A/D conversion circuit, acquires an image of an object in front of the user wearing the apparatus as digital image data, and outputs the image data to the ROM 113.

The line-of-sight direction acquiring unit 116 is, for example, a line-of-sight detection module based on a corneal reflection method, and acquires a target direction (direction of interest) of the user (a line-of-sight direction of the user).

Based on information on the target direction of the user acquired by the line-of-sight direction acquiring unit 116, the object detector 117 detects an object present in the target direction (a target object or object of interest) and sets a target point. The object detector 117 also outputs, to the RAM 114, supplementary information on the detected object (object feature values such as color and luminance histograms) in order to transmit the supplementary information to the image pickup apparatus 120.

The image processing unit 118 generates image data obtained by applying various image processing such as white balance adjustment, color interpolation, and gamma processing to image data stored in the ROM 113. The image processing unit 118 further calculates, by coordinate transformation, a region in which a spatial region captured by the image pickup apparatus 120 exists within image data obtained by the imaging unit 115, generates CG having a shape of a truncated square pyramid by connecting boundaries of the calculated region with line segments, and superimposes the CG on the image data.

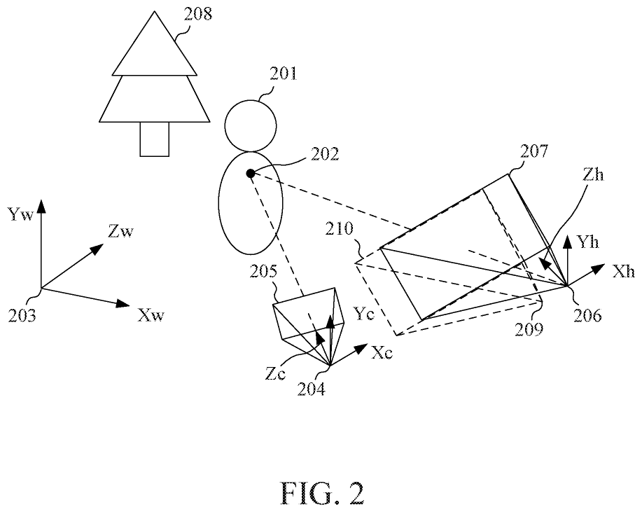

Here, a coordinate system according to the present embodiment will be described with reference to FIG. 2. FIG. 2 is a diagram for explaining the coordinate system. Reference numeral 201 denotes an object to be created as a three-dimensional model. Reference numeral 202 denotes a target point of the user through the display apparatus 110. Reference numeral 203 denotes an origin of a world coordinate system, which includes Xw, Yw, and Zw axes. Reference numeral 204 denotes an origin of a coordinate system of the image pickup apparatus 120, which includes Xc, Yc, and Zc axes, and will be referred to as a camera coordinate system hereinafter. Reference numeral 205 denotes an imaging surface of the image pickup apparatus 120. Reference numeral 206 denotes an origin of a coordinate system for a right-eye camera in the display apparatus 110, which includes Xh, Yh, and Zh axes, and will be referred to as a display coordinate system hereinafter. Reference numeral 207 denotes an imaging surface for the right-eye camera in the display apparatus 110. Information for a left-eye camera is represented by a dashed line, in which reference numeral 209 denotes an origin of a coordinate system and reference numeral 210 denotes an imaging surface for the left-eye camera. In the following description, processing will be described using image data for the right-eye camera. The imaging surface for the right-eye camera and the imaging surface for the left-eye camera are arranged so as to coincide with each other by shifting in an Xh direction. Reference numeral 208 denotes an object present in a background region relative to the object 201 and not to be created in a three-dimensional model.

In FIG. 2, it is assumed that the user does not look through a viewfinder of the image pickup apparatus 120 and is therefore unable to recognize the angle of view of the image pickup apparatus 120. In the following description, it is assumed that an angle of view acquired by the display apparatus 110 is wider than an angle of view acquired by the image pickup apparatus 120.

The position and orientation estimator 119 calculates (estimates) a position and orientation of the display apparatus 110 in the world coordinate system. Camera internal parameters of the display apparatus 110 are assumed to be known.

Here, camera internal parameters K are defined by a focal length of the camera and optical center coordinates, and are specifically represented by the following matrix. It is assumed that the lens has no distortion.

$$K = [ \begin{matrix}{f}_{x} & 0 & {c}_{x} \\ 0 & {f}_{y} & {c}_{y} \\ 0 & 0 & 1\end{matrix} ]$$

Here, fx and fy are focal lengths of the camera, and cx and cy are optical center coordinates of the camera.

The image pickup apparatus 120 is, for example, a mirrorless camera. The image pickup apparatus 120 includes a control unit 121, a ROM 122, a RAM 123, an imaging unit 124, an image processing unit 125, a position and orientation estimator 126, and an operation unit 127.

A description of the control unit 121, the ROM 122, and the RAM 123 will be omitted because they are similar to those of the control unit 111, the ROM 113, and the RAM 114.

The imaging unit 124 includes an optical system, an image sensor, and an A/D conversion circuit. The optical system includes, for example, a magnification varying lens for changing a focal length and a focus lens for focusing. The optical system also includes an aperture stop, and a light amount during imaging is adjusted by adjusting an aperture diameter of the optical system using the aperture stop. An optical image formed on the image sensor by the optical system is photoelectrically converted, A/D conversion processing is applied to an obtained analog image signal, and obtained digital image data is output to and stored in the ROM 122.

The image processing unit 125 outputs, to the ROM 122, image data obtained by applying various image processes such as white balance adjustment, color interpolation, and gamma processing to image data stored in the ROM 122.

The position and orientation estimator 126 calculates (estimates) a position and orientation of the image pickup apparatus 120 in the world coordinate system. The camera internal parameters of the image pickup apparatus 120 are assumed to be known.

The operation unit 127 includes an aperture operation member and the like, and enables changing an imaging condition of the image pickup apparatus 120.

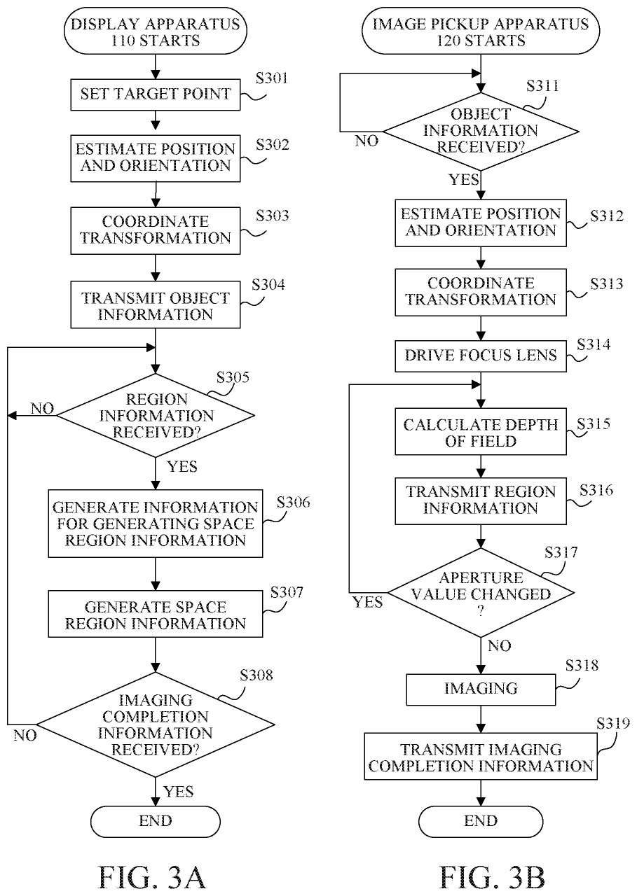

A description will now be given of an assist display operation in the display apparatus 110 when capturing images for creating a three-dimensional model of the object 201 using the image pickup apparatus 120 in the situation illustrated in FIG. 2. FIGS. 3A and 3B are flowcharts for explaining an operation of the display processing system 100.

FIG. 3A is a flowchart for explaining an operation of the display apparatus 110. Each processing illustrated in FIG. 3A is executed by the control unit 111 by developing programs recorded in the ROM 113 in the RAM 114.

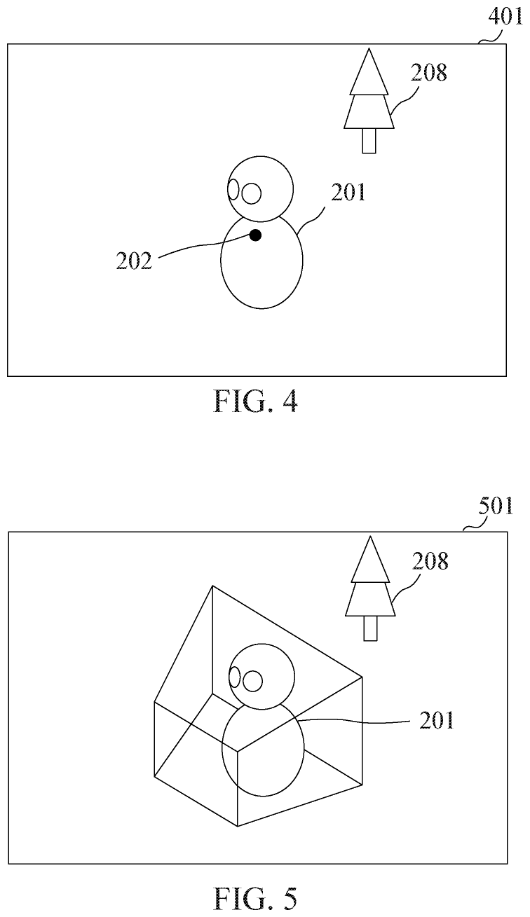

In step S301, the line-of-sight direction acquiring unit 116 acquires a target direction of the user. Based on information on the target direction of the user, the object detector 117 detects, in image data acquired by the imaging unit 115 for the right eye, an object present at a target destination, and sets a target point (xh, yh). The object detector 117 also outputs supplementary information on the detected object to the RAM 114 in order to transmit the supplementary information to the image pickup apparatus 120. FIG. 4 is a diagram for explaining image data 401 acquired by the imaging unit 115. As illustrated in FIG. 4, the display apparatus 110 captures the object 201 with an angle of view that looks down on the object 201 obliquely from above.

In step S302, the position and orientation estimator 119 estimates a position and orientation of the display apparatus 110 by referring to current image data and image data acquired before the current image data. More specifically, the position and orientation are estimated from an image data group using a technology such as Structure from Motion (SfM). The position and orientation may be estimated using an acceleration sensor or an angular velocity sensor, or may be estimated by combining these sensors. The position and orientation estimated here correspond to camera external parameters T, which include a rotational component and a translational component and are represented by the following matrix:

$$T = [ R \vert t ] = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {r}_{3}\end{matrix} ]$$

Here, r11, r12, r13, r21, r22, r23, r31, r32, and r33 are rotational components of the camera, and t1, t2, and t3 are translational components of the camera.

Coordinates (u, v) in image data acquired by the imaging unit 115 and three-dimensional coordinates (X, Y, Z) in the world coordinate system are convertible by the following expression (1) using camera internal parameters K and camera external parameters T:

$$s [ \begin{matrix}u \\ v \\ 1\end{matrix} ] = KT [ \begin{matrix}X \\ Y \\ Z \\ 1\end{matrix} ] = K [ R \vert t ] [ \begin{matrix}X \\ Y \\ Z \\ 1\end{matrix} ] \qquad ( 1 )$$

Here, s is a coefficient representing scale ambiguity.

In step S303, the position and orientation estimator 119 converts the target point (xh, yh) set in step S301 and a distance zh from the display apparatus 110 to the target point into three-dimensional coordinates (Xh, Yh, Zh) in the world coordinate system. The distance zh to the target point may be measured by stereo distance measurement using a right-eye image and a left-eye image.

From expression (1), an equation for the conversion is represented by the following expression (2):

$$[ \begin{matrix}Xh \\ Yh \\ Zh\end{matrix} ] = {R}^{t} ( {K}^{- 1} zh [ \begin{matrix}xh \\ yh \\ 1\end{matrix} ] - t ) \qquad ( 2 )$$

In step S304, three-dimensional coordinates (Xh, Yh, Zh) of the target point and supplementary information on the object are transmitted to the image pickup apparatus 120 as object information.

In step S305, it is determined whether region information generated in step S316 described below has been received by the image pickup apparatus 120. In a case where it is determined that the region information has been received, processing in step S306 is executed; otherwise, processing of the present step is executed again.

In step S306, the image processing unit 118 generates information for generating spatial region information in accordance with region information, which is information on a depth direction in which a target object exists. In the present embodiment, the region information is three-dimensional coordinates (Xci, Yci, Zci) (i=1 to 8) of eight points determined based on an angle of view of the image pickup apparatus 120 and a region of the object (information in the depth direction) determined by a depth of field, as described below. The image processing unit 118 converts the three-dimensional coordinates (Xci, Yci, Zci) of the eight points into coordinates (vertex position information) in image data in the display apparatus 110 in accordance with expression (1), and acquires the converted coordinates as information for generating the spatial region information. Since it is assumed that the position and orientation of the display apparatus 110 change with time, camera external parameters are assumed to be updated each time.

In step S307, the image processing unit 118 generates the spatial region information using the information acquired in step S306. Here, the spatial region information is information for recognizing content to be captured by the image pickup apparatus 120 (a three-dimensional spatial region captured by the image pickup apparatus 120). More specifically, the image processing unit 118 first generates image data by applying various image processes such as white balance adjustment, color interpolation, and gamma processing to image data stored in the ROM 113. Next, the image processing unit 118 generates, as the spatial region information, CG having a shape of a truncated square pyramid by connecting the coordinates acquired in step S306 with line segments. The spatial region information is displayed by being superimposed on the image data by the display unit 112. FIG. 5 is a diagram for explaining, as assist information to be displayed on the display apparatus 110, the spatial region information, and illustrates a state in which the spatial region information is superimposed on the image data. Only the object 201 to be created in the three-dimensional model is surrounded by the CG having a truncated square pyramid shape, indicating that the image pickup apparatus 120 is oriented in a desired direction and captures the object with a proper aperture setting. Thus, even without looking through a viewfinder of the image pickup apparatus 120, the user can recognize content to be captured by the image pickup apparatus 120, and perform imaging for photogrammetry while recognizing circumstances. Further, the user can recognize a depth-of-field state in the depth direction at the same time, and capture an image in which an object has no depth blur or generate a high-quality three-dimensional model. CG for the left eye can be generated by shifting CG for the right eye by a shift amount of the imaging surface, and the shifted CG is superimposed on left-eye image data.

In step S308, it is determined whether imaging completion information transmitted in step S319 described below has been received by the image pickup apparatus 120. When it is determined that the imaging completion information has been received, this flow ends; otherwise, processing in step S305 is executed.

FIG. 3B is a flowchart for explaining an operation of the image pickup apparatus 120. Each processing illustrated in FIG. 3B is executed by the control unit 121 by a developing program recorded in the ROM 122 in the RAM 123.

In step S311, it is determined whether the object information transmitted in step S304 by the display apparatus 110 has been received. In a case where it is determined that the object information has been received, processing in step S312 is executed; otherwise, processing of this step is executed again.

In step S312, the position and orientation estimator 126 estimates a position and orientation of the image pickup apparatus 120 by a method similar to that in step S302.

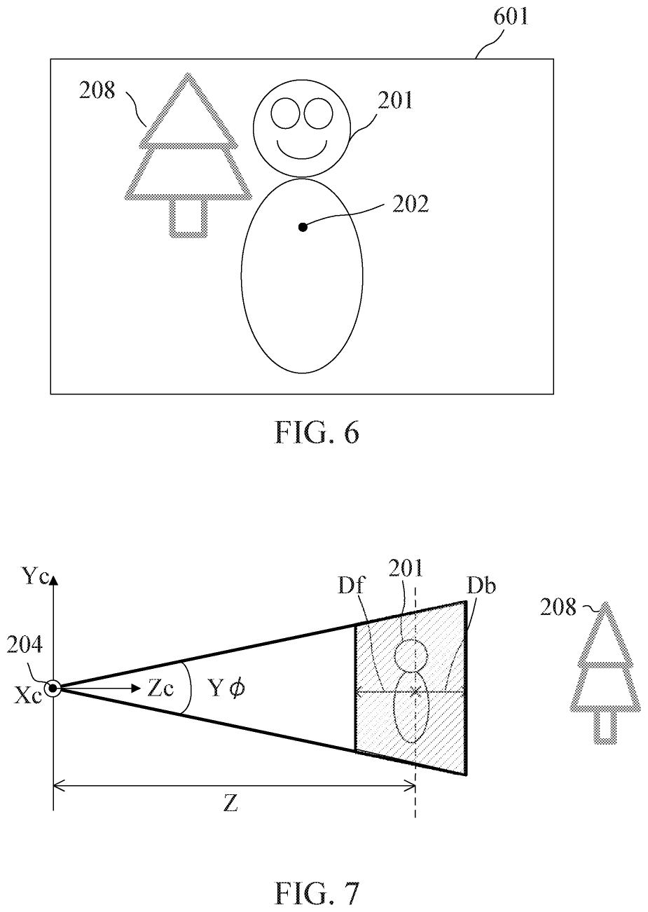

In step S313, the position and orientation estimator 126 converts the three-dimensional coordinates (Xh, Yh, Zh) of the target point received in step S311 into coordinates in image data of the image pickup apparatus 120 by conversion using expression (1). FIG. 6 is a diagram for explaining image data acquired by the image pickup apparatus 120, and illustrates image data captured by the image pickup apparatus 120. The entire body of the object 201 is captured from the front, and the object 208 exists in the background thereof.

In step S314, the imaging unit 124 drives a focus lens so as to focus on the object 201 having the target point. At this time, in order to improve focusing accuracy on the object, the object may be detected again with reference to the supplementary information on the object received in step S311.

In step S315, the imaging unit 124 calculates a depth of field when the image pickup apparatus 120 focuses on the object 201. The depth of field is represented by Z−Df to Z+Db using a front depth of field Df, a rear depth of field Db, and an in-focus object distance Z. Df is represented by (r·Av·Z\hat{ }2)/(f\hat{ }2+r·Av·Z), and Db is represented by (r·Av·Z\hat{ }2)/(f\hat{ }2−r·Av·Z). Here, r is a circle of confusion diameter, Av is an aperture value (F-number), and f is a focal length. The circle of confusion diameter r is set to twice a pixel pitch. FIG. 7 is a diagram for explaining a spatial region determined based on an angle of view of the image pickup apparatus 120 and a region of the object determined according to a depth of field when the image pickup apparatus 120 focuses on the object 201. A spatial region cut out by a vertical angle of view Yφ and the front depth of field Df and the rear depth of field Db at the in-focus object distance Z is indicated by hatching. To generate a high-quality three-dimensional model through photogrammetry, it is necessary to input images in which the object does not extend out of the angle of view and the object is within the depth of field without depth blur. Transmitting to the user the spatial region indicated by hatching in FIG. 7 can assist imaging for photogrammetry. In FIG. 7, the object 201 to be created in the three-dimensional model is within the hatched portion and satisfies a proper imaging condition. Further, the object 208, which is not to be created in the three-dimensional model, is located outside the spatial region indicated by hatching in FIG. 7.

Although the circle of confusion diameter r is set to twice the pixel pitch in the present embodiment, the present disclosure is not limited to this example, and r may be set to be coarser or finer according to, for example, the number of polygons of three-dimensional data to be created.

Although the depth of field is set to Z−Df to Z+Db, the present disclosure is not limited to this example, and the range may have a margin in width, for example, Z−2·Df to Z+2·Db, in consideration of errors of the focal length f and the aperture value Av obtainable by the camera.

The present embodiment determines the region of the object according to the depth of field when the image pickup apparatus 120 focuses on the object 201; however, the present disclosure is not limited to this example. For example, the region of the object may be determined according to a distance range in which the object 201 exists. In this case, information Z+ΔZ in the depth direction of the object may be calculated from a defocus value calculated for each pixel position in a phase-difference image obtained from the image sensor in which all pixels are phase-difference pixels. The information Z+AZ in the depth direction can be derived from a lens formula (1/Z+1/Z′=1/f and 1/(Z+ΔZ)+1/(Z′+def)=1/f) where f is a focal length of the lens. Thereby, since the depth of the object can be grasped with fine accuracy, the aperture value can be set more finely.

In step S316, the position and orientation estimator 126 converts coordinate positions of eight points for representing the spatial region indicated by hatching in FIG. 7 into three-dimensional coordinates in the world coordinate system using expression (2). Here, the positions of the eight points correspond to the vertex positions of a trapezoid indicated by hatching in FIG. 7, and further correspond to the vertex coordinate positions of a truncated square pyramid when the Xc direction is also considered. The converted coordinates are transmitted to the display apparatus 110 as region information.

In step S317, it is determined whether the aperture value has been changed. When it is determined that the aperture value has been changed, processing in step S315 is executed; otherwise, processing in step S318 is executed. In a case where an exposure compensation setting is fixed, as the aperture value is increased (the aperture is narrowed), the depth of field becomes deeper, and as a result, the exposure time becomes longer or the ISO speed increases. As the exposure time increases, the influences of camera shake or object blur increase, and when the ISO speed increases, noise increases. Accordingly, by changing the aperture value using the operation unit 127 while viewing CG having the truncated square pyramid shape rendered on the display unit 112, the user can find the aperture value at which the depth of field does not become excessively deep. A configuration may be adopted in which proper settings are automatically performed by the image pickup apparatus 120 and the user only checks the result. In any case, imaging can be performed with a proper aperture value setting for photogrammetry.

In step S318, exposure processing is performed by the imaging unit 124, and image data for photogrammetry processed by the image processing unit 125 is recorded in the ROM 122.

In step S319, command information (imaging completion information) is transmitted to the display apparatus 110 in order to notify that the imaging processing in step S318 has been completed.

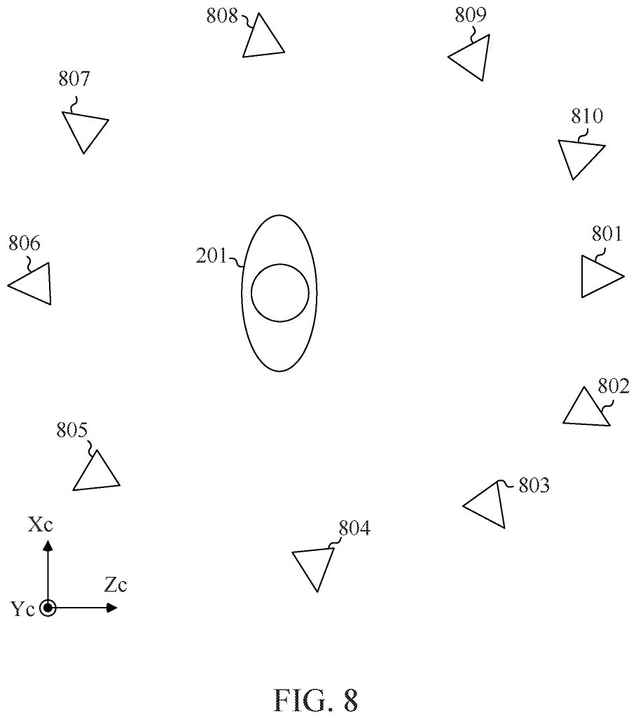

After imaging is completed in step S318, as illustrated in FIG. 8, the user moves to the next imaging position and continues imaging while changing positions and orientations so as to surround the object 201. FIG. 8 is a bird's-eye view viewed from above, and reference numerals 801 to 810 indicate positions and orientations of the image pickup apparatus 120.

Setting of imaging parameters and exposure operations in the image pickup apparatus 120 may be automatically performed. Thereby, the user can pay more attention by recognizing the user's steps or circumstances, and can safely capture an image. In this case, the timing for starting the exposure operation may be determined by monitoring a moving amount of the image pickup apparatus 120 and starting the exposure when the movement exceeds a predetermined amount. This configuration enables an image set for photogrammetry to be captured with a proper recording capacity.

While photogrammetry has been described as a means for creating a three-dimensional model, the present disclosure is not limited to this example, and a known technology such as neural rendering may be used.

In FIG. 7, in a case where there is a region in which the object 201 extends out of an angle of view of the image pickup apparatus 120 (that is, at least a part of the object 201 is located outside the angle of view of the image pickup apparatus 120), the user may be notified of such a state in order to prompt the user to change the angle of view. More specifically, CG in FIG. 5 may be rendered (or drawn) with a changed color (for example, a color of a surface or a line in which the object extends out). Alternatively, text such as “The object is out of the field of view. Please rotate the camera to the left.” may be displayed. Any method may be used as long as the user can be notified that there is a region in which the object 201 extends out of the angle of view of the image pickup apparatus 120. For example, vibration or sound may be used.

There may be a case where the angle of view of the image pickup apparatus 120 does not enter the field of view captured by the display apparatus 110 at all, such as when capturing the top of the head of a stone statue on a pedestal by stretching an arm and capturing from above. In a case where such a situation is determined based on position and orientation estimation results of the display apparatus 110 and the image pickup apparatus 120, image data generated by the image processing unit 125 of the image pickup apparatus 120 may be displayed in a region such as corners of the display unit 112 where the field of view is less obstructed. Thereby, even in a situation in which an object field captured by the image pickup apparatus 120 is difficult for the user to recognize in imaging for photogrammetry, desired imaging can be performed.

The image processing unit 118 may generate a three-dimensional model from a plurality of image sets that have been captured by the image pickup apparatus 120 using photogrammetry or neural rendering technologies, and display the generated three-dimensional model on the display unit 112. Thereby, the quality of the three-dimensional model can be checked on site, and re-imaging can be properly performed, thereby improving the imaging efficiency.

As described above, the configuration of the present embodiment, when performing imaging for photogrammetry, can display assist information such that images can be captured under proper imaging conditions while allowing the user to recognize circumstances.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. One or more of the functional blocks illustrated in FIG. 1 may be implemented by hardware such as an ASIC or a programmable logic array (PLA), or by a programmable processor such as a CPU or MPU executing software. They may also be implemented by a combination of software and hardware. Therefore, even when different functional blocks are described as the main operation entities in the following description, they may be implemented by the same hardware.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure provides a display apparatus that can display assist information that enables images to be captured under a proper imaging condition while allowing a user to recognize circumstances when performing imaging for photogrammetry.

What is claimed is:

1. A display apparatus communicably connected to an image pickup apparatus, the display apparatus comprising:
one or more memories storing instructions;
one or more processors that, upon execution of the instructions, operate to:
detect an object that is present in a line-of-sight direction of a user, and
generate spatial region information according to an angle of view of the image pickup apparatus and a region of the object; and
a display unit configured to display the spatial region information.

2. The display apparatus according to claim 1, wherein the region of the object is determined according to a depth of field when the image pickup apparatus is focused on the object.

3. The display apparatus according to claim 1, wherein the region of the object is determined according to a distance range in which the object exists.

4. The display apparatus according to claim 1, wherein the spatial region information is CG having a shape of a truncated square pyramid.

5. The display apparatus according to claim 4, wherein the one or more processors operate to generate vertex position information on the truncated square pyramid using a relationship between a position and orientation of the image pickup apparatus and a position and orientation of the display apparatus.

6. The display apparatus according to claim 1, wherein, in a case where at least a part of the object is located outside the angle of view, the one or more processors operate to notifies the user that at least the part of the object is located outside the angle of view.

7. The display apparatus according to claim 6, wherein the spatial region information includes CG having a shape of a truncated square pyramid, and
wherein, in a case where at least the part of the object is located outside the angle of view, the display unit changes a color of the CG.

8. The display apparatus according to claim 6, wherein, in a case where at least the part of the object is located outside the angle of view, the display unit displays text indicating that at least the part of the object is located outside the angle of view.

9. The display apparatus according to claim 1, wherein the one or more processors generates a three-dimensional model from a plurality of images acquired by the image pickup apparatus using photogrammetry or a neural rendering technology.

10. The display apparatus according to claim 1, wherein, in a case where there is no overlapping region between the angle of view of the image pickup apparatus and an angle of view of the display apparatus, the display unit displays image data generated by the image pickup apparatus.

11. The display apparatus according to claim 1, wherein the one or more processors operate to acquire the line-of-sight direction of the user.

12. A display processing method of a display apparatus including a display unit and communicably connected to an image pickup apparatus, the display processing method comprising:
detecting an object that is present in a line-of-sight direction of a user;
generating spatial region information according to an angle of view of the image pickup apparatus and a region of the object; and
displaying the spatial region information.

13. A non-transitory computer-readable storage medium storing a program that causes a computer to execute the display processing method according to claim 12.
